(19) United States
(12) Patent Application Publication
(10) Pub. No.: US 2026/0244979 A1
(43) Pub. Date: Aug. 20, 2026

(54) PRIVACY PRESERVING WORKFLOW FOR REPRODUCIBLE MACHINE LEARNING TRAINING ITERATIONS

(71) Applicant: OPTUM, INC., Minnetonka, MN (US)

(72) Inventors: Kunal Suri, Greater Noida (IN); Saumajit Saha, Bangalore (IN); Albert Aristotle Nanda, Bengalura (IN); Prakhar Mishra, Gurgaon (IN)

(21) Appl. No.: 19/057,347

(22) Filed: Feb. 19, 2025

(51) Int. Cl. H04L 9/08; G06F 8/71; G06N 20/00; H04L 9/06

(52) U.S. Cl. CPC G06N 20/00; G06F 8/71; G06N 3/08; H04L 9/0643; H04L 9/0894

(57) ABSTRACT

Techniques for tracking machine learning model training iterations that preserve privacy, increase security, and reduce memory and other computing resources are disclosed herein. An example computer-implemented method comprises generating one or more hash values corresponding to raw data associated with a machine-learned model training process, the raw data comprising a first raw data point associated with a first key and the one or more hash values comprising a first hash value; storing the first hash values in a database in association with the first key; executing a first processing stage using the first raw data point to generate a processed data point; generating a hash value for the first processed data point; storing the second hash value in association with the first key; training a machine-learned model using processed data to generate a trained machine-learned model; and registering the trained machine-learned model.

### BACKGROUND

Version Control Software (VCS) can be used to track versions of machine learned models, but such software typically only works with managing versions of smaller files such as the code and metrics for the models. VCS generally lacks the ability to handle larger files (e.g., files greater than 50 MB), which means it is not well suited to storing large data and model files. Moreover, storing data files using VCS presents privacy and security issues, as the data files may contain sensitive information, and removing such data may be risky as the VCS stores the entire history of the project.

Additionally, tracking and deploying models in production may be difficult. Current techniques include creating a folder on a server at which the model is to be deployed, storing the best performing model in that folder, and backing up other models in other folders. Such techniques are neither scalable nor easy to maintain. A similar issue exists with respect to creating different releases for different versions of software, which may be achieved by using a VCS. Again, however, such a solution is infeasible for deploying models because, as previously mentioned, a VCS is typically not well suited to handle larger files such as model files.

### BRIEF DESCRIPTION OF THE DRAWINGS

The Figures described below depict preferred embodiments for purposes of illustration only. One skilled in the art will readily recognize from the following discussion that alternative embodiments of the systems and methods illustrated herein may be employed without departing from the principles of the disclosure described herein.

FIG. 1 depicts an example computing system in which various embodiments of the present disclosure may be implemented.

FIG. 2 depicts an example flow diagram for hashing data.

FIG. 3A depicts an example of hashing and processing data.

FIG. 3B depicts an example of datapoints being changed and dropped as a result of the processing the data.

FIG. 3C depicts an example of using hash values to track data through processing stages.

FIG. 4 depicts a flow diagram representing an example computer-implemented method, in accordance with various embodiments described herein.

### DETAILED DESCRIPTION

Broadly speaking, the techniques of the present disclosure enable private, secure, and efficient storage and tracking of data that is used to train and execute machine learning models and/or architectural features of a machine learning models that may result from different stages of training using the data (e.g., models parameters) and/or hyperparameters defining a machine learning model at such different stages. More specifically, the techniques of the present disclosure include generating, using a deterministic hashing function, one or more hash values corresponding to raw data associated with a machine-learned model training process, the raw data comprising a first raw data point associated with a first key and storing the one or more hash values in a database in association with the first key. The techniques of the present disclosure then execute a processing stage of a set of one or more processing stages to generate a processed data point (e.g., converting text to lower case, converting images to black and white, resampling audio to a chosen sample rate, changing the format of date and/or time, etc.), generate a hash value corresponding to the processed data point, and storing the hash value corresponding to the processed data point in association with the first key. The techniques of the present disclosure use the processed data to train a machine-learned model, and register the trained-machine learned model in a model registry that may be separate from the database. The techniques of the present disclosure improve the functioning of a computer at least by: (1) enhancing the privacy and security of storing and tracking changes to data, and (2) reducing the amount of computing resources needed for a machine learning process.

As mentioned above, existing techniques for conducting machine learning training iterations typically include storing raw code, model architecture hyperparameters, training hyperparameters, model parameters that result from training, model metrics, and/or data files for each machine learning training iteration. Storing the raw data may present privacy and/or cybersecurity issues, as the raw data may contain sensitive information. While it may be possible to remove sensitive information from the raw data, such removal may be difficult and may create a risk of unintentionally affecting other components of the machine learning model training iteration. For example, other components may be accidentally deleted or rendered non-functional. To avoid some of the issues stemming from raw data storage, some existing techniques may encrypt data prior to storage. However, such encryption generally fails to alleviate these privacy/security concerns by enabling recreation of the raw data using, e.g., a private key or a password.

By contrast, the techniques of the present disclosure overcome these challenges present in existing techniques to enhance data privacy and security. In particular, the present techniques leverage a deterministic hashing function to hash data after changes to the data and store the hash values to create a record of such changes without saving the raw data. Namely, using the deterministic hashing function to create hash values representing data changes disables reengineering/recreation of the raw data, as cryptographic hash functions are designed to be one-way functions (i.e., it is infeasible or impossible to decrypt a hash to reproduce the original data used to create the hash). In other words, while a data point may be converted into a hash value, it may be computationally infeasible to reverse the process and generate the original data point from the hash value. This one-way property ensures that even if someone has access to the hash value, they cannot reconstruct the original data, in contrast to the data encryption utilized in existing techniques. A deterministic hashing function will always produce the same hash value for the same input, but a change in the input data may result in a significantly different hash value. Any changes to the input can therefore be tracked via the hash values without the need for storing and observing the original input data, as if the input data is unchanged the hash value will also remain unchanged, but if the input data changes the hash value will also change. Additionally, because even a minor change in the input data may result in a significantly different hash value (i.e., the avalanche effect), privacy and security are further protected as the hash values cannot be used to predict or infer the original input data. Furthermore, cryptographic hash functions are designed to be collision-resistant, meaning it is highly unlikely for two different inputs to produce the same hash value, which further increases the difficulty of attempting to reverse-engineer the original data from its hash value. Thus, the present techniques can pinpoint when data changes occur during a training process due to the deterministic nature of the hashing function, while avoiding the privacy/security issues present in existing techniques that store raw data.

Further, storing the hash values rather than the raw data improves the functioning of the underlying computer or computing system by reducing the memory resources required to record changes to data during a machine learning experiment. Generally, hash functions produce hash values of a fixed size, regardless of the size of the input data. For example, the SHA-256 hash function will always produce a hash value of 256 bits (32 bytes). In many cases, this fixed size of the hash value may be significantly smaller than the input data. Furthermore, in some applications such as machine learning training processes, the raw data may undergo processing and may change. Tracking changes through each processing stage may be important for a machine learning training process, but saving every version of the data as it is processed may utilize vast amounts of memory, leading to inefficiencies in memory storage. Moreover, storing an entire dataset and version of the data uses significantly more memory the larger the dataset becomes, presenting scalability issues. By contrast, using hash values alleviates these memory challenges and inefficiencies. Changes to input data may be tracked by using hash values (as discussed above) while using less memory resources than storing every version of data, as hash values tend to be smaller than the input data. The use of hash values also more effectively accommodates larger datasets, without proportional increases in memory requirements. Thus, storing hash values provides a more efficient use of memory resources. Reducing the memory resources required to track changes to the data may also enable the underlying computer or computing system to more efficiently handle larger datasets and computations.

The techniques of the present disclosure also include storing the model and data separately, which improves the functioning of the computer by making the system less vulnerable to data corruption and database failure, and eliminates the dependency of the model on the database. For example, data corruption and database failure may occur due to hardware failures and/or malfunctions, software errors, and/or malicious attacks. Databases may also be unavailable during maintenance of the database and/or other systems. If data is corrupted the corruption will not directly affect the model, preserving the model's integrity. By contrast, storing the model with the data presents a risk that the data corruption could compromise the model. If the database fails or is otherwise inaccessible, the model may still operate independently of the database if the database and model are stored separately. Furthermore, the model may be deployed, managed, and/or updated without being directly affected by the database constraints and/or performance. Storing the model separately from the database may likewise reduce the amount of computing resources utilized in the system by eliminating the need for retraining the model due to data corruption or database failure. Storing a machine-learned model with the database presents a risk that the model may be lost due to data corruption or database failure, and retraining the model may require significant computing resources and time. By contrast, storing the model separately from the database may eliminate the need for retraining the model, as the model will still be available for registration and use even if the data is corrupted or the database fails.

Furthermore, decoupling the database and the data tracking system (e.g., a data version control software) reduces the amount of computing resources needed. For example, when the database and data tracking components are tightly integrated, issues in the data tracking system, such as data corruption, could necessitate retraining a machine-learned model, which is a resource-intensive process. By decoupling the database and data tracking components may eliminate unnecessary retraining, thereby conserving computational power and storage.

Allowing model registration to occur independently of the data tracking system may introduce a level of operational flexibility that can be a significant technical advantage. A machine-learned model may be updated or modified without needing to interact with or make changes to the data tracking system. This flexibility facilitates easier maintenance, updates, and scalability of the machine-learned model, as changes can be implemented more swiftly and with fewer dependencies.

The techniques of the present disclosure may further reduce use of computing resources, as they may eliminate the need for managing cloud resources, storage resources, and network resources, and creating clusters for service orchestration. Additionally, eliminating the use of such resources and services may eliminate the use of a costly and complex infrastructure. Thus, storing the model separately from the system provides a more robust, failure-resistant system that conserves computing resources.

Of course, it should be appreciated that the advantages and technical improvements described above and elsewhere herein are not the only advantages and/or technical improvements that may be realized as a result of the techniques described herein. Other advantages and/or technical improvements to the functioning of a computer itself or other technologies or technical fields may be apparent to one of ordinary skill in the art.

### Example Computing System

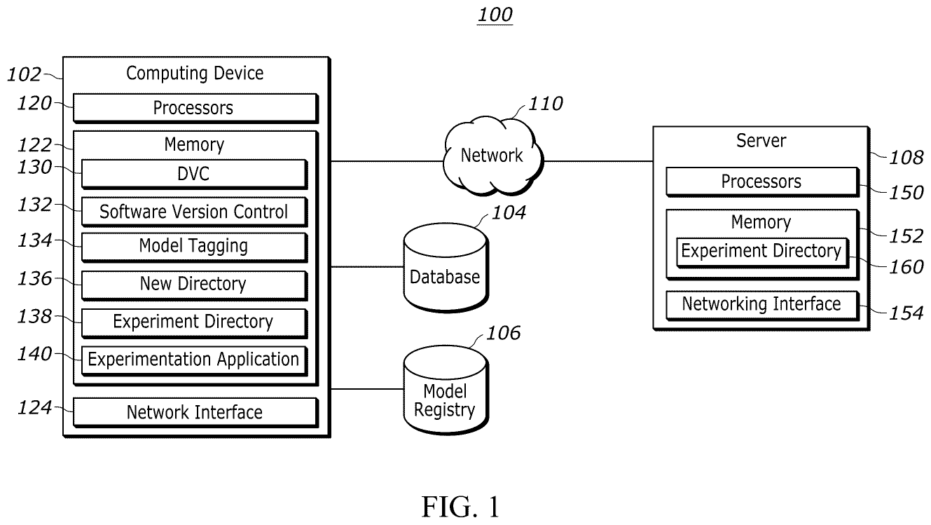

FIG. 1 may depict an example computing system 100 in which various embodiments of the present disclosure may be implemented. It should be appreciated that, while the various components of the example computing system 100 (e.g., computing device 102, database 104, model registry 106, etc.) are illustrated in FIG. 1 as single components, the example computing system 100 may include multiple (e.g., dozens, hundreds, thousands) of computing devices 102. Generally, the example computing system 100 may include a computing device 102, a database 104, and a model registry 106.

More specifically, the computing device 102 may include one or more processors 120, a memory 122, and a networking interface 124. The one or more processors 120 may include any suitable number of processors and/or processor types. For example, the processors 120 may each include one or more CPUs and one or more graphics processing units (GPUs). Generally, each of the processors 120 may be configured to execute software instructions stored in the memory 122. The memory 122 may include one or more persistent memories (e.g., a hard drive and/or solid-state memory) and may store one or more applications, components, and/or models, such as a data version control (DVC) component 130, a software version control component 132, a model tagging component 134, a new directory 136, an experiment directory 138, an experimentation application 140, and a networking interface 124.

The memory 122 may store executable instructions that are configured to, when executed by the one or more processors 120, cause the one or more processors 120 to process data, generate hash values for data, store hash values, train a machine learned model, and register a machine learned model. The memory 122 may also store additional data and/or databases.

The memory 122 may include a data version control (DVC) component 130. The DVC component 130 may manage, control, and track different versions of data, alternate data, machine-learned models (e.g., their hyperparameters and/or parameters), training hyperparameters, and/or model metrics. The DVC component 130 may be implemented using any suitable version control program (e.g., DVC, Git Large File Storage (LFS), Dolt, Nessie, lakeFS, etc.). In some embodiments, the DVC component 130 may include a hashing function to generate one or more hash values for data. In some embodiments, the hashing function is separate from the DVC component. In some embodiments, the hashing function may utilize a deterministic hashing algorithm, such as a locality sensitive hash function, such as the Nilsimsa hashing algorithm, ssdeep, sdhash, TLSH, xxHash, or the like, or other deterministic hashing algorithms, such as SHA-256, MD5, and/or the like.

The memory 122 may include a software version control component 132. The software version control component 132 manages and tracks versions of code for the machine learned model training iterations. For example, the software version control component 132 may track changes to code files in a repository (e.g., the new directory 136 which is initialized as a software version control repository), including adding, modifying, and deleting files. Code files may include application source code, scripts, configuration files, etc. The code files may include code written in programming languages such as Python, C, C++, C#, Java, JavaScript, etc. The software version control component 132 may be a distributed version control system such that each code developer has a full history of the code repository stored locally (e.g., on a computing device 102). For example, the software version control component 132 may be a version control system such as Git. Initializing a folder (e.g., a directory) as a Git repository may create a hidden . git folder that includes other files and folders that store project files and a complete version history of the code. Git may monitors and stores changes to all files and folders in the . git directory. When code is committed, Git may take a “snapshot” of the code to record it, and may generate a hash (e.g., a secure hash algorithm 1 (SHA-1) hash) that is assigned to the commit and stored. Changes may be reverted to a previous version of the code with a git restore. Branches, which may include pointers to different commits, may be created and used to develop code without impacting the main branch, and may be merged into the main branch once code is ready to be integrated into the main branch. Tags may be another type of pointer that are immovable and may be used to identify different commits, such as different versions of the code (e.g., by using model tagging component 134 such as Git Tag Ops as explained further below). For example, a machine learning model experiment for developing a machine learned model may include different branches for different versions of code, so that different versions of the code may exist and a desired branch of code may be merged into the main branch.

The memory 122 may include a tagging component 134. The tagging component 134 is used to register a machine-learned model by assigning a version to the model. As explained above, tags may be used to identify different versions of code. In some embodiments, the tagging component 134 may be Git Tag Ops (GTO), which may work with Git and manage model versions by creating annotated Git tags in a special format.

The memory 122 may include a new directory 136. The new directory 136 may include one or more subdirectories and store a machine learning model training iteration. The new directory may be initialized as a DVC repository and a Git repository. Raw files for a machine learning model training iteration may be copied from the experiment directory 138 and added to the new directory 136.

The memory 122 may include an experiment directory 138. The experiment directory 138 may store all of the raw files related to a particular machine learning training iteration such as raw code, model architecture hyperparameters, training hyperparameters, model parameters that result from training, model metrics, and/or data files. The code may include instructions for training and/or operating a machine-learned model. Generally speaking, machine learning may be implemented through machine learning methods and algorithms. In some embodiments, at least one of a plurality of machine learning methods and algorithms may be used which may include, but are not limited to: linear or logistic regression, instance-based algorithms, regularization algorithms, decision trees, Bayesian networks, cluster analysis, association rule learning, artificial neural networks, deep learning, combined learning, reinforced learning, dimensionality reduction, and support vector machines. In various embodiments, the implemented machine learning methods and algorithms are directed toward at least one of a plurality of categorizations of machine learning, such as supervised learning, unsupervised learning, and reinforcement learning. For example, a machine learning process may include utilizing deep learning to detect cancer in images. The structure of the experiment directory 138 may be replicated in the new directory 136, and the raw files may be added into the new directory 136.

The memory 122 may include an experimentation application 140. The experimentation application 140 may include instructions for one or more processing stages for processing data. For example, the experimentation application 140 may be used to prepare (i.e., preprocess) data for a machine learning training iteration. The experimentation application 140 may perform operations such as converting text to lower case, converting images to black and white, resampling audio to a chosen sample rate, changing the format of date and/or time, etc.

The computing device 102 may include a networking interface 124, which may enable the computing device 102 to communicate with the server 108 and/or any other suitable devices or combinations thereof. More specifically, the networking interface 124 enables the computing device 102 to communicate with each component of the example computing system 100 across the network 110 through their respective networking interfaces 124, 154. The networking interface 124 may support wired or wireless communications, such as USB, Bluetooth, Wi-Fi Direct, Near Field Communication (NFC), etc. The networking interface 124 may enable the computing device 102 to communicate with the various components of the example computing system 100 via a wireless communication network such as a fifth-, fourth-, or third-generation cellular network (5G, 4G, or 3G, respectively), a Wi-Fi network (802.11 standards), a WiMAX network, or any other suitable wide area network (WAN), local area network (LAN), or personal area network (PAN), etc.

The database 104 may be a No-SQL based database, such as Redis or MongoDB, a relational database, such as Oracle, DB2, MySQL, or another suitable database. The database 104 may store hashed values of data that is used to train and/or operate one or more machine-learned models, artifacts (e.g., model metrics and model hyperparameters), and other training iteration-related information. In some embodiments, the database 104 may be an in-memory database.

The model registry 106 may be a repository used to store trained machine-learned models. The model registry may be a separate database that is decoupled from the database 104 so that it does not depend on the database 104. For example, if the database 104 fails or is otherwise unavailable, a model that is trained on new data may still be registered in the model registry 106. Registering a model may include storing a trained machine-learned model, including documenting details such as a version number of the model, performance metrics of the model, and model hyperparameters.

The computing system 100 may include a server 108. The server 108 may be used so that a computing device 102 may obtain, use, and/or modify the files and code of an official version of a machine learning training iteration. In some embodiments, the computing system 100 may include a plurality of computing devices that may obtain files and code from the server 108. The server 108 may include one or more processors 150, a memory 152, and a networking interface 154. The one or more processors 120 may include any suitable number of processors and/or processor types. For example, the processors 120 may each include one or more CPUs and one or more graphics processing units (GPUs). Generally, each of the processors 120 may be configured to execute software instructions stored in the memory 122. The memory 122 may include one or more persistent memories (e.g., a hard drive and/or solid-state memory) and may store an experiment directory 160.

The experiment directory 160 may include files and code of an official version of a machine learning experiment. A computing device 102 may obtain the data of the experiment directory 160 from the server 108 and copy them into the experiment directory 138 on the computing device 102. In some embodiments, a user may modify a machine learning experiment. Such modifications may be pushed to the server 108 and an updated version of the machine learning training iteration code and/or files may be saved in the experiment directory 160.

The networking interface 154 may enable the server 108 to communicate with the computing device 102 and/or other components of the example computing system 100 across the network 110. For example, the server 108 may transmit the files and code stored in the experiment directory 160 to a computing device 102 via the networking interface 154. The networking interface 154 may support wired or wireless communications, such as USB, Bluetooth, Wi-Fi Direct, Near Field Communication (NFC), etc. The networking interface 154 may enable the server 108 to communicate with the various components of the example computing system 100 via a wireless communication network such as a fifth-, fourth-, or third-generation cellular network (5G, 4G, or 3G, respectively), a Wi-Fi network (802.11 standards), a WiMAX network, or any other suitable wide area network (WAN), local area network (LAN), or personal area network (PAN), etc.

The network 110 may be a single communication network, or may include multiple communication networks of one or more types (e.g., one or more wired and/or PANs or LANs, and/or one or more WANs such as the Internet). In some embodiments, the network 110 comprises multiple, entirely distinct networks (e.g., one or more networks for communications between computing device 102 and server 108, and a separate, Bluetooth or wireless LAN (WLAN) network for communications between computing device 102 and server 108, and so on).

In operation, the new directory 136 may be initialized as a DVC repository and as a Git repository. The subdirectory structure of the experiment directory 138 may be replicated in the new directory 136, and the raw files from the experiment directory 138 may be added to the new directory 136. Each data point in the raw data that was copied into the new directory 136 from the experiment directory 138 may be assigned a respective unique key. The DVC component 130 may generate a respective hash value for each data point in the raw data. Each hash value for each data point may be stored in association with its respective key in a database 104. The raw data may be processed by the experimentation application 140, which may include one or more processing stages, to generate processed data. The DVC component 130 may generate hash values for the processed data. The hash values may be stored in the database 104, with the hash value for a particular processed data point stored in association with its respective key. The data may continue to be processed by the experimentation application 140 until it is ready to be used for training a machine learned model, with hash values generated for the data in between each processing stage included in an experimentation application 140.

It will be understood that the above disclosure is one example and does not necessarily describe every possible embodiment. As such, it will be further understood that alternate embodiments may include fewer, alternate, and/or additional steps or elements.

### Example Data Processing And Hashing

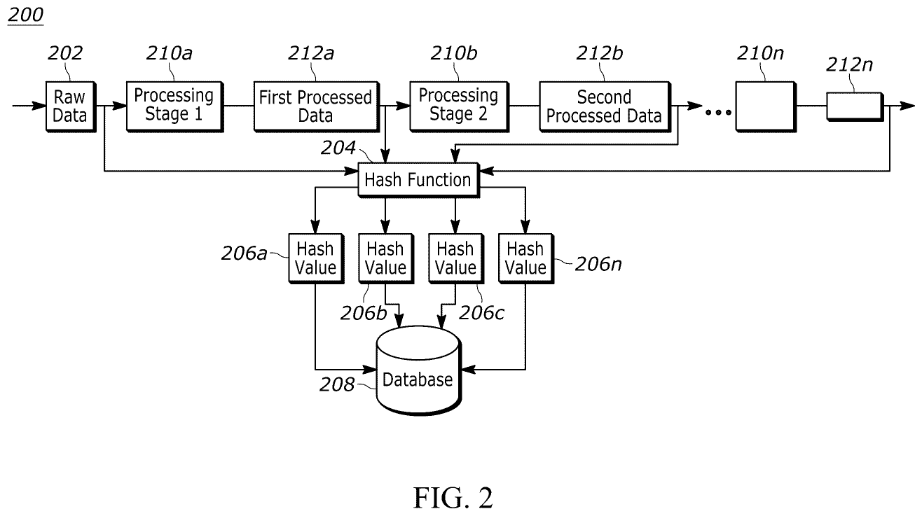

FIG. 2 may depict a process 200 for processing, hashing, and storing data for training a machine-learned model. In some implementations, the process 200 may also be used for processing data for the inference (i.e., non-training) stage of a machine-learning model training iteration, where the data is input to the machine-learned model to generate output.

Raw data 202 may comprise one or more raw datapoints and may include unprocessed data used in the training and/or inference stages of a machine learning training iteration. The raw data 202 may be processed via one or more processing stages 210a . . . 210n to transform the data into a suitable form for the training and/or inferences stages of a machine learning training iteration.

The raw data 202 may be input to a hash function 204 to generate one or more hash values 206 for the raw data 202. The hash function may be a function that takes an input and maps it to a fixed-size value, which is called the hash code or hash value. In some embodiments, the hash function may be a deterministic hash function, i.e., the same input to a hash function will always produce the same output. In some embodiments, the hash function may be any deterministic hashing algorithm. Each datapoint in the raw data 202 is hashed to generate a corresponding hash value in the set of hash values 206a.

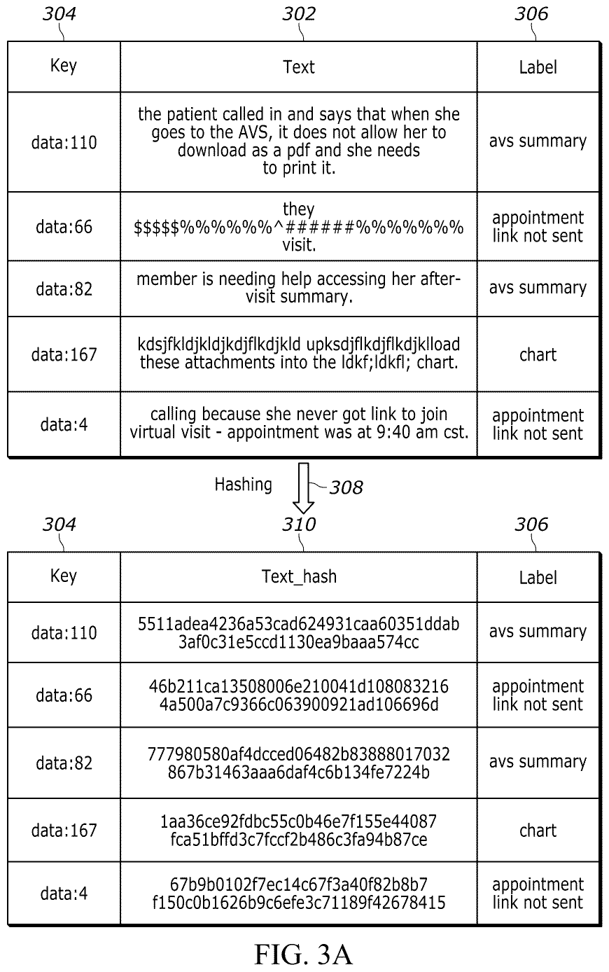

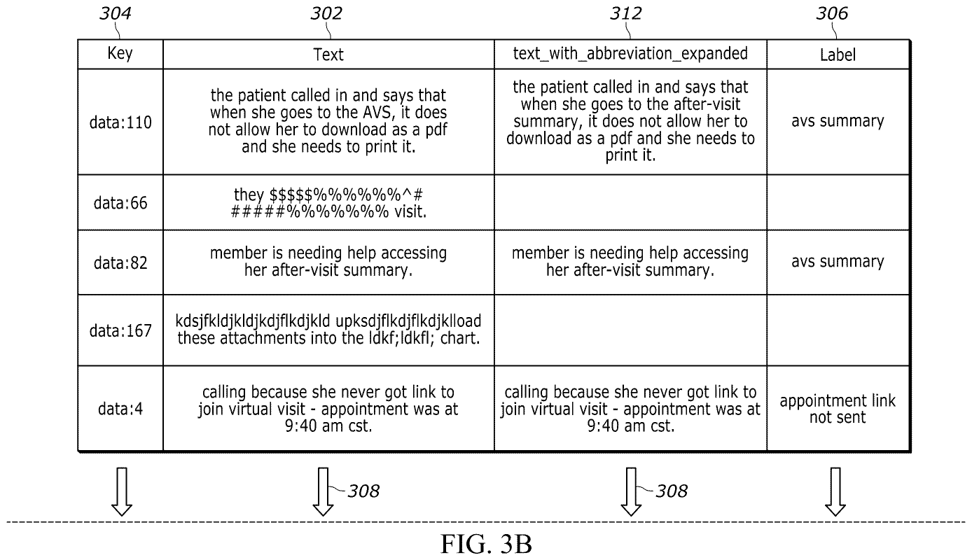

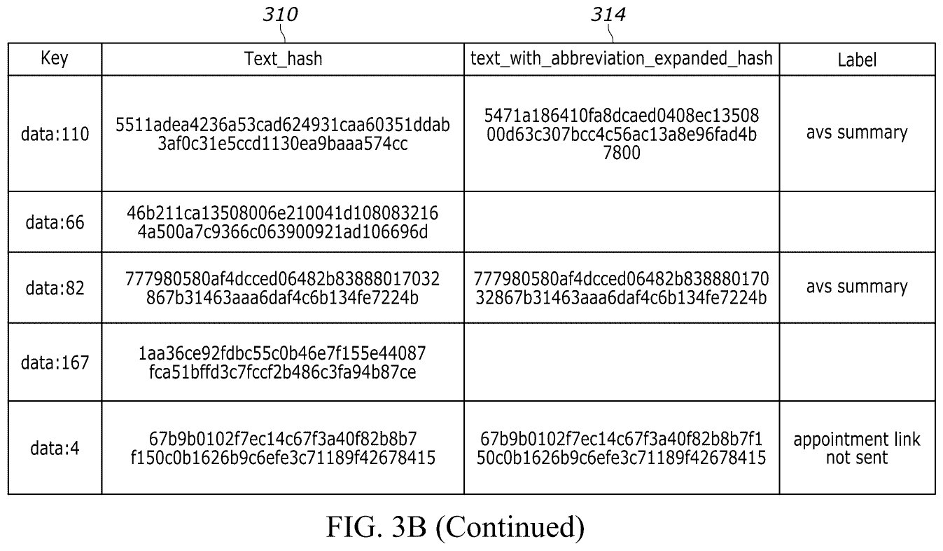

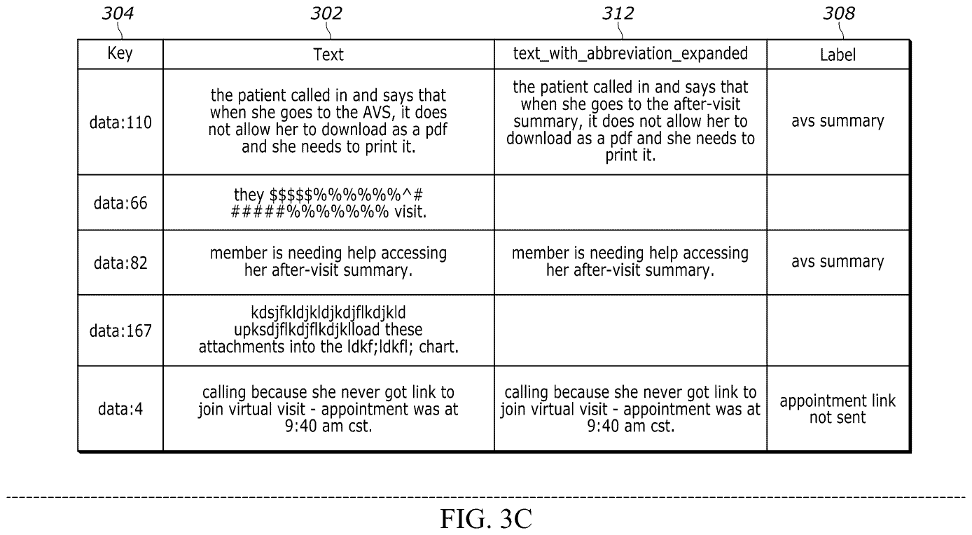

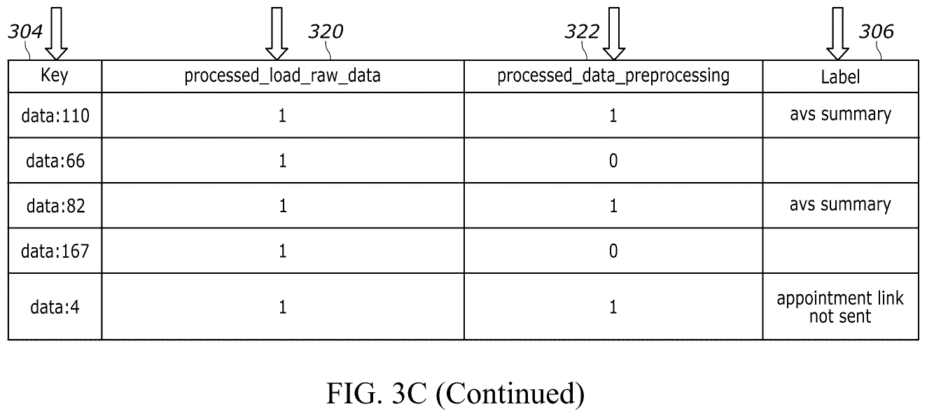

The set of hash values 206a may be stored in a database 208. Each hash value in the set of hash values 206a may be stored in the database 208 in association with a key, as shown in FIGS. 3A-3C. A key may be a unique identifier used to reference a datapoint as it undergoes processing at processing stages 210a . . . 210n. The key may ensure that any changes to the datapoints may be tracked, as only the hash values of a datapoint, and not the actual value of the datapoint, may be stored in the database 208 to ensure privacy.

The raw data 202 may be processed through a series of processing stages 210a . . . 210n. Each processing stage 210a . . . 210n may be a pre-processing step and may include an operation such as converting text to lower case, converting images to black and white, resampling audio to a chosen sample rate, changing the format of date and/or time, etc. A hash function 204 may be applied to the output data 212a . . . 212n of each processing stage 210a . . . 210n to generate sets of hash values 206b . . . 206n. Each hash value in the sets of hash values 206b . . . 206n may be stored in the database 208 in association with their respective keys.

For example, the raw data 202 may be processed at a first processing stage 210a, resulting in an output of first processed data 212a. The hash function 204 may be used on the first processed data 212a to generate a set of hash values 206b, wherein each datapoint of the first processed data 212a may have a corresponding a hash value in the set of hash values 206b. The set of hash values 206b may be stored in the database 208. Each hash value in the set of hash values 206b may be stored in association with a corresponding key. For example, a first hash value of the set of hash values 206b may be stored in association with a first primary key corresponding to a first datapoint, a second hash value of the set of hash values 206b may be stored in association with a second primary key corresponding to a second datapoint, etc.

The first processed data 212a may undergo a second processing stage 210b, resulting in an output of second processed data 212b. The hash function 204 may be used on the second processed data 212b to generate a set of hash values 206c, wherein each datapoint of the second processed data 212b may have a corresponding a hash value in the set of hash values 206c. The set of hash values 206c may be stored in the database 208. Each hash value in the set of hash values 206c may be stored in association with a corresponding primary key. For example, a first hash value of the set of hash values 206c may be stored in association with a first primary key corresponding to a first datapoint, a second hash value of the set of hash values 206c may be stored in association with a second primary key corresponding to a second datapoint, etc.

The second processed data 212b may undergo subsequent processing stages until a last processing stage 210n, resulting in nth processed data 212n. The hash function 204 may be used on the nth processed data 212n to generate a set of hash values 206n, wherein each datapoint of the nth processed data 212n may have a corresponding a hash value in the set of hash values 206n. The set of hash values 206n may be stored in the database 208. Each hash value in the set of hash values 206n may be stored in association with a corresponding primary key. For example, a first hash value of the set of hash values 206n may be stored in association with a first primary key corresponding to a first datapoint, a second hash value of the set of hash values 206n may be stored in association with a second primary key corresponding to a second datapoint, etc. While the set of hash values 206n may be stored in the database 208, the hash values may not be used to train a machine-learned model or used in a machine learning training iteration. The nth processed data 212n may ultimately be used to train a machine-learned model or used in a machine learning training iteration, but is not stored in the database 208.

FIG. 3A may depict an example of hashed data. Input data 302 may be used for training a machine-learned model and/or for inference stages of a machine-learned model. In some embodiments, data 302 may be text data, as in FIG. 3A. In some embodiments, input data 302 may be image data, audio data, video data, etc. The input data 302 may be associated with a primary key 304. The primary key 304 may be a unique identifier used to reference a datapoint through various processing stages, and may ensure that any changes to the datapoints may be tracked. For example, in FIG. 3A, the text data “the patient called in and says that when she goes to the AVS, it does not allow her to download as a pdf and she needs to print it.” may be associated with the key “data:110”. In some embodiments, the input data 302 may also be associated with other attributes, such as a label 306 as shown in FIG. 3A.

A hashing function 308 may be used on the input data 302 to generate hash values 310 for the input data 302. The hashing function 308 may be a deterministic hashing function, i.e., the same input will generate the same output. Each datapoint of the input data 302 may have a corresponding hash value 310. For example, the text data “the patient called in and says that when she goes to the AVS, it does not allow her to download as a pdf and she needs to print it.” may be hashed to generate the corresponding hash value “5511adea4236a53cad624931caa60351ddab3af0c31e5ccd1130ea9baaa574cc”. The hashing function 308 may generate a fixed-length output, regardless of the length of the input. For example, the text datapoint “the patient called in and says that when she goes to the AVS, it does not allow her to download as a pdf and she needs to print it.” is 147 characters, while the text datapoint “member is needing help accessing her after-visit summary.” is 57 characters. However, the hash values for both datapoints (“5511adea4236a53cad624931caa60351ddab3af0c31e5ccd1130ea9baaa574cc” and “777980580af4dcced06482b83888017032867b31463aaa6daf4c6b134fe7224b” respectively) are both 64 characters long. The hash values may be associated with a primary key 304 and may be stored in a database in association with the primary key 304. For example, the hash value “5511adea4236a53cad624931caa60351ddab3af0c31e5ccd1130ea9baaa574cc” may be stored in association with the key “data:110”. While the original raw datapoint “the patient called in and says that when she goes to the AVS, it does not allow her to download as a pdf and she needs to print it.” may not be stored, any changes that occur to the datapoint as it is processed may be able to be tracked as the hash value of the datapoint is stored in association with the primary key associated with the datapoint, as described further below with reference to FIG. 3B.

FIG. 3B may depict datapoints being changed and dropped as a result of the processing the data. As in FIG. 3A, input data 302 may be used for training a machine-learned model and/or for an inference stage of a machine learning training iteration and may be text data. The data 302 may be associated with a primary key 304 and other attributes such as a label 306.

The input data 302 may undergo a preprocessing step (i.e., a processing stage) to generate processed data 312. A processing stage may include an operation such as converting text to lower case, converting images to black and white, resampling audio to a chosen sample rate, changing the format of date and/or time, etc. In FIG. 3B, the input data 302 may be text data and may be processed to expand abbreviations. For example, the abbreviations in text data “the patient called in and says that when she goes to the AVS, it does not allow her to download as a pdf and she needs to print it.” may be expanded such that the processing stage generates the processed text data “the patient called in and says that when she goes to the after-visit summary, it does not allow her to download as a pdf and she needs to print it.”

A hashing function 308 may be applied to the processed data 312 to generate a processed data hash value 314 corresponding to the processed data 312. For example, in FIG. 3B, hashing the processed text data “the patient called in and says that when she goes to the after-visit summary, it does not allow her to download as a pdf and she needs to print it.” generates a hash value “5471a186410fa8dcaed0408ec1350800d63c307bcc4c56ac13a8e96fad4b7800.” The processed data hash value 314 may be stored in association with a corresponding primary key 304. For example, in FIG. 3B, the hash value “5471a186410fa8dcaed0408ec1350800d63c307bcc4c56ac13a8e96fad4b7800” may be stored in association with the primary key “data:110”.

Although the actual input data 302 is not stored, any changes to the input data 302 after it is processed may be observed due to the changes in the hash values. For example, in FIG. 3B, the text data “the patient called in and says that when she goes to the AVS, it does not allow her to download as a pdf and she needs to print it.”, which is associated with the primary key “data:110”, is changed as a result of the processing stage. As a result, the hash value for the processed data is different than the hash value for the unprocessed data. However, a user will be able to identify the hash value “5511adea4236a53cad624931caa60351ddab3af0c31e5ccd1130ea9baaa574cc” and the processed data hash value “5471a186410fa8dcaed0408ec1350800d63c307bcc4c56ac13a8e96fad4b7800” as being associated with the same datapoint, even if the user does not know what the datapoint is, through the primary key “data:110”, as both the hash value and the processed data hash value are both stored in association with the key “data:110”. The user will also be able to observe that a change in the datapoint has occurred between one processing stage and the next, as only a change in the datapoint would result in the hash value differing from the processed data hash value.

In contrast, the text data “member is needing help accessing her after-visit summary.” May be unchanged after a processing stage that expands abbreviations. As a result, the processed data hash value (“777980580af4dcced06482b83888017032867b31463aaa6daf4c6b134fe7224b”) generated for the processed text data may be the same as hash value for the unprocessed text data.

FIG. 3C may depict tracking dropped datapoints. As in FIGS. 3A and 3B, input data 302 may be used for training a machine-learned model and/or for machine learning inference and may be text data. The input data 302 may be associated with a primary key 304 and other attributes such as a label 306. As in FIG. 3B, the input data 302 may undergo a preprocessing step (i.e., a processing stage) to generate processed data 312.

Not all data points may be processed to generate processed data 312. For example, the data associated with the primary key “data:66” may not be processed to generate a processed data point. Data may be dropped for being corrupted. For example, in FIG. 3C, the text data associated with the primary key “data: 66” is “they $$$$$%%%%%%^######%%%%%%% visit.” Thus, the data point associated with the primary key “data: 66” may not undergo the processing step and may bedropped, and no hash value may be calculated for the dropped data point.

Tracking dropped data points may be achieved by using flags. As shown in FIG. 3C, a primary key 304 may be stored in association with a flag 320 that may indicate whether raw data has been loaded for processing (“processed_load_raw_data”), such that “1” may indicate that the raw data has been loaded and “0” may indicate that data has not been loaded. The primary key 304 may also be stored in association with a flag 322 that may indicate whether data has been processed (“processed_data_preprocessing”), such that “1” may indicate that the data has been processed and “0” may indicate that the data has not been processed. For example, text data associated with the primary key “data:110” may have been loaded, so the flag 320 indicating that the data has been loaded may be set to “1”. The data associated with the primary key “data:110” may also have been processed, so the flag 322 indicating the data has been processed may be set to “1”. In contrast, the data point associated with the primary key “data:66” may also have been loaded (flag 320 set to “1”), but the data point may have been dropped and not processed, so flag 322 may be set to “0”.

### Example Computer-Implemented Methods

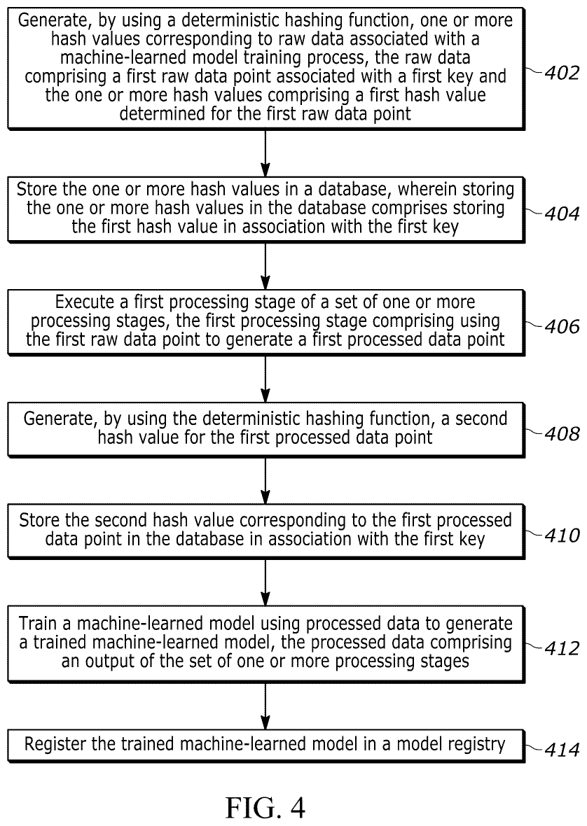

FIG. 4 may depict a flow diagram of an exemplary computer-implemented method in accordance with various embodiments described herein. One or more operations of the method 400 may be implemented as a set of instructions stored on a computer-readable memory and executable on one or more processors. The method 400 may be implemented via one or processors of the example computing device 102, such as the processors 120, for example.

At operation 402, the method 400 may include generating, by one or more processors and using a deterministic hashing function, one or more hash values corresponding to raw data associated with a machine-learned model training process, the raw data comprising a first raw data point associated with a first primary key.

At operation 404, the method 400 may include storing one or more hash values in a database in association with the first primary key.

At operation 406, the method may include executing a processing stage of a set of one or more processing stages to generate a processed data point.

At operation 408, the method 400 may include a hash value corresponding to the processed data point is generated, by using the deterministic hashing function. In some embodiments, a data version control (DVC) application may execute the hashing function. In some embodiments, the hashing function may be separate from the DVC.

At operation 410, the method 400 may include storing the hash value corresponding to the processed data point in the database in association with the first primary key.

At operation 412, the method 400 may include training a machine-learned model using processed data to generate a trained machine-learned model. The processed data may comprise an output of the set of one or more processing stages.

At operation 414, the method 400 may include registering the trained machine-learned model in a model registry. In some embodiments, the model registry may be separate from the database. In some embodiments, registering the trained machine-learned model may comprise tagging the trained machine-learned model using a model tagging tool (e.g., Git Tag Ops). Tagging the machine learned model may include assigning a version number to the trained machine-learned model.

In some embodiments, the method 400 may further include initializing a directory in the memory 122 as a software version control repository. The method 400 may include initializing the same directory as a data version control (DVC). A structure of an experiment directory (e.g., experiment directory 138 of FIG. 1) storing data files associated with a machine-learned model training iteration may be replicated in the directory that is initialized as a software version control and DVC repository, such as the new directory 136 of FIG. 1. One or more of the data files containing raw alternate data from the experiment directory 138 may be added to the new directory 136 such that the data files may be managed and tracked by the DVC application. One or more code files from the experiment directory 138 may be added to the new directory 136 such that the code files may be managed and tracked by the software version control application.

In some embodiments, the method 400 may further include modifying one or more parameters (e.g., weight(s), bias(es), split function(s), node split(s), etc. and/or activation function(s), number of layer(s), etc. in examples where the activation function(s), number of layer(s) and/or node(s), etc. are tunable alterable) of the machine-learned model to generate a tuned machine-learned model. The tuned machine-learned model may be registered using a model tagging tool (e.g., Git Tag Ops). In some embodiments, the modified parameters may be stored in a database. In some embodiments, metrics measuring the performance (e.g., accuracy, precision, sensitivity, F1 score, receiver operating characteristic (ROC) curve, area under the ROC curve (AUC), specificity, mean absolute error (MAE), mean squared error (MSE), root mean squared error (RMSE)) may be determined and stored in a database.

In some embodiments, the method 400 may further include determining one or more metrics measuring a performance of the trained machine-learned model. The one or more metrics of the trained machine-learned model may be stored in the database by using the DVC application.

In some embodiments, the method 400 may further include modifying the one or more code files. The one or more modified code files may be stored in a directory that has been initialized as a software version control repository, such as the new directory 136. The modified code files may be tracked by the software version control application.

In some embodiments, the method 400 may further include generating, by using the deterministic hashing function, one or more experiment hash values corresponding to raw alternate data associated with a trained machine-learned model training iteration, the raw alternate data comprising a first raw alternate data point associated with a first experiment primary key and storing the one or more experiment hash values in a database in association with the first experiment primary key. The method 400 may include executing a processing stage of a set of processing stages to generate a processed data point. A hash value corresponding to the processed datapoint may be generated by using the deterministic hashing function, and the hash value corresponding to the processed data point may be stored in the database in association with the first experiment primary key. A trained machine-learned model may be applied to the processed data to generate an output associated with the experiment. Based on the output, one or more model metrics may be determined, and the model parameters may be adjusted based on the one or more model metrics.

In some embodiments, the method 400 may further include tracking changes in data. The method 400 may include executing a second processing stage resulting in a change to the data point. Using the deterministic hashing function, a second hash value may be generated for the datapoint, and the resulting second hash value may be different from the first hash value. The second hash value may be stored in the database in association with the first key and an identification of the second processing stage resulting in a change to the first datapoint.

In some embodiments, the method 400 may further include tracking dropped data points. The method 400 may include executing the first processing stage of a set of processing stages on a second raw data point and a third raw data point to generate a second processed data point and a third processed data point and generating, by using the deterministic hashing function, a second hash value for the second processed data point and a third hash value for the third processed data point. The second hash value may be stored in association with a second primary key and the third hash value in association with a third primary key. The method 400 may include executing a second processing stage of a set of processing stages on the first processed data point, the second processed data point, and the third processed data point. The method 400 may include determining that the second processed datapoint is absent or that no output was generated after the executing of the second processing stage and generating a fourth hash value for the first processed datapoint and a fifth hash value for the third processed datapoint and setting a flag indicating that the second processed datapoint is absent or that no output was.

### EXAMPLES

Example 1. A computer-implemented method comprising: generating, by one or more processors and using a deterministic hashing function, one or more hash values corresponding to raw data associated with a machine-learned model training process, the raw data comprising a first raw data point associated with a first key and the one or more hash values comprising a first hash value determined for the first raw data point; storing, by the one or more processors, the one or more hash values in a database, wherein storing the one or more hash values in the database comprises storing the first hash value in association with the first key; executing, by the one or more processors, a first processing stage of a set of one or more processing stages, the first processing stage comprising using the first raw data point to generate a first processed data point; generating, by the one or more processors and using the deterministic hashing function, a second hash value for the first processed data point; storing, by the one or more processors, the second hash value corresponding to the first processed data point in the database in association with the first key; training a machine-learned model using processed data to generate a trained machine-learned model, the processed data comprising an output of the set of one or more processing stages; and registering the trained machine-learned model in a model registry.

Example 2. The computer-implemented method of example 1, wherein the model registry is separate from the database.

Example 3. The computer-implemented method of example 1 or 2, further comprising: initializing, by the one or more processors, a first directory as a software version control repository and as a data version control (DVC) repository; replicating, in the first directory, a structure of an experiment directory, the experiment directory storing data files from a machine-learned model training iteration; adding, by the one or more processors, one or more data files containing the raw data from the experiment directory to the first directory to be tracked by a DVC application, wherein the DVC application stores and monitors changes to the one or more hash values and the hash value corresponding to the first processed data point; and adding, by the one or more processors, one or more code files from the experiment directory to the first directory to be tracked by a software version control application, wherein the one or more code files comprise instructions for training and using the machine-learned model.

Example 4. The computer-implemented method of any of examples 1 through 3, further comprising: generating, by the one or more processors and using the deterministic hashing function, one or more experiment hash values corresponding to raw operation data associated with a trained machine-learned model training iteration, the raw operation data comprising a first raw operation data point associated with a first experiment key; storing, by the one or more processors, the one or more experiment hash values in a database in association with the first experiment key; executing, by the one or more processors, the first processing stage of a set of processing stages to generate a first processed data point; generating, by the one or more processors and using the deterministic hashing function, a hash value corresponding to the first processed data point; storing, by the one or more processors, the hash value corresponding to the first processed data point in the database in association with the first experiment key; determining, by the trained machine-learned model and based on the first processed data point, an output; determining, by the one or more processors, a loss based on the output; adjusting one or more model parameters to reduce the loss; and storing, by the one or more processors, the one or more model parameters.

Example 5. The computer-implemented method of any of examples 1 through 4, further comprising: modifying, by the one or more processors, one or more parameters of the trained machine-learned model to generate a tuned machine-learned model; registering, by the one or more processors, the tuned machine-learned model using a model tagging tool; and storing, by the one or more processors and using a DVC application, the one or more modified parameters in the database.

Example 6. The computer-implemented method of any of examples 1 through 5, further comprising: executing, by the one or more processors and based at least in part on the first processed data point, a second processing stage resulting in a modified first processed data point; generating, by the one or more processors and using the deterministic hashing function, a third hash value for the modified first processed data point, wherein the third hash value is different from the second hash value; and storing, by the one or more processors, the third hash value in the database in association with the first key and an identification of the second processing stage.

Example 7. The computer-implemented method of any of examples 1 through 6 further comprising: executing, by the one or more processors, the first processing stage of a set of processing stages on a second raw data point to generate a second processed data point, the second raw data point being associated with a second key; generating, by the one or more processors and using the deterministic hashing function, a third hash value for the second processed data point; storing, by the one or more processors, the third hash value in association with the second key; executing, by the one or more processors, a second processing stage of a set of processing stages on the first processed data point and the second processed data point; determining, by the one or more processors, that the second processed data point is absent or that no output was generated for the second processed data point after the executing of the second processing stage; and generating, by the one or more processors, a fourth hash value for the first processed data point.

Example 8. A computer system comprising: one or more processors; and one or more memories storing processor-executable instructions that, when executed by the one or more processors, cause the one or more processors to perform operations comprising the method of any one of Examples 1-7.

Example 9. One or more non-transitory computer-readable media storing processor-executable instructions that, when executed by one or more processors, cause the one or more processors to perform operations comprising the method of any one of Examples 1-7.

### ADDITIONAL CONSIDERATIONS

Throughout this specification, components, operations, or structures described as a single instance may be implemented as multiple instances. Although individual operations of one or more methods (or processes, techniques, routines, etc.) are illustrated and described as separate operations, two or more of the individual operations may be performed concurrently or otherwise in parallel, and nothing requires that the operations be performed in the order illustrated. Structures and functionality (e.g., operations, steps) presented as separate components in example configurations may be implemented as a combined structure, functionality, or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, operations, or instructions. These may constitute and/or be implemented by software (e.g., code embodied on a non-transitory, machine-readable medium), hardware, or a combination thereof. In hardware, the routines, etc., may represent tangible units capable of performing certain operations and may be configured or arranged in a certain manner. In example embodiments, one or more computer systems (e.g., a standalone, client or server computer system) or one or more hardware components of a computer system (e.g., a processor or a group of processors) may be configured by software (e.g., an application or application portion) as a hardware component that operates to perform certain operations as described herein.

In various embodiments, a hardware component may be implemented mechanically or electronically. For example, a hardware component may comprise dedicated circuitry or logic that is permanently configured (e.g., as a special-purpose processor, such as a field programmable gate array (FPGA) or an application-specific integrated circuit (ASIC)) to perform certain operations. A hardware component may also or instead comprise programmable logic or circuitry (e.g., as encompassed within one or more general-purpose processors and/or other programmable processor(s)) that is temporarily configured by software to perform certain operations.

Accordingly, the term “hardware component” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where the hardware components include a general-purpose processor configured using software, the general-purpose processor may be configured as respective different hardware components at different times. Software may accordingly configure a processor, for example, to constitute a particular hardware component at one instance of time and to constitute a different hardware component at a different instance of time.

Hardware components can provide information to, and receive information from, other hardware components. Accordingly, the described hardware components may be regarded as being communicatively coupled. Where multiple of such hardware components exist contemporaneously, communications may be achieved through signal transmission (e.g., over appropriate circuits and buses) that connect the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information).

As noted above, the various operations of example methods (or processes, techniques, routines, etc.) described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions. The components referred to herein may, in some example embodiments, comprise processor-implemented components.

Moreover, each operation of processes illustrated as logical flow graphs may represent a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

The terms “coupled” and “connected,” along with their derivatives, may be used. In particular embodiments, “connected” may be used to indicate that two or more elements are in direct physical or electrical contact with each other, although the context in the description may dictate otherwise when it is apparent that two or more elements are not in direct physical or electrical contact. “Coupled” may mean that two or more elements are in direct physical or electrical contact. However, “coupled” may also mean that two or more elements are not in direct contact with each other, yet still co-operate, transmit between, or interact with each other.

An algorithm may be considered to be a self-consistent sequence of acts or operations leading to a desired result. These include physical manipulations of physical quantities. Usually, though not necessarily, these quantities take the form of electrical, magnetic, or optical signals capable of being stored, transferred, combined, compared, and otherwise manipulated. These signals are commonly referred to as bits, values, elements, symbols, characters, terms, numbers, flags, or the like. It should be understood, however, that all of these and similar terms are to be associated with the appropriate physical quantities and are merely convenient labels applied to these quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments,” “one embodiment,” “an embodiment,” “in some examples,” or variations thereof means that a particular element, feature, structure, characteristic, operation, or the like described in connection with the embodiment is included in at least one embodiment, but not every embodiment necessarily includes the particular element, feature, structure, characteristic, operation, or the like. Different instances of such a reference in various places in the specification do not necessarily all refer to the same embodiment, although they may in some cases. Moreover, different instances of such a reference may describe elements, features, structures, characteristics, operations, or the like be combined in any manner as an embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless the context of use clearly indicates otherwise, “or” refers to an inclusive or and not to an exclusive or. For example, a condition A or B is satisfied by any one of the following: A is true (or present) and B is false (or not present), A is false (or not present) and B is true (or present), and both A and B are true (or present).

The term “set” is intended to mean a collection of elements and can be a null set (i.e., a set containing zero elements) or may comprise one, two, or more elements. A “subset” is intended to mean a collection of elements that are all elements of a set, but that does not include other elements of the set. A first subset of a set may comprise zero, one, or more elements that are also elements of a second subset of the set. The first subset may be said to be a subset of the second subset if all the elements of the first subset are elements of the second subset, while also being a subset of the set. However, if all the elements of the second subset are also elements of the first subset (in addition to all the elements of the first subset being elements of the second subset), the first subset and the second subset are a single subset/not distinct.

For the purposes of the present disclosure, the term “a” or “an” entity refers to one or more of that entity. As such, the terms “a” or “an”, “one or more”, and “at least one” can be used interchangeably herein unless explicitly contradicted by the specification using the word “only one” or similar. For example, “a first element” may functionally be interpreted as “a first one or more elements” or a “first at least one element.” Unless otherwise apparent from the context of use, reference in the present disclosure to a same set of “one or more processors” (or a same “plurality of processors,” etc.) performing multiple operations can encompass implementations in which performance of the operations is divided among the processor(s) in any suitable way. For example, “generating, by one or more processors, X; and generating, by the one or more processors, Y” can encompass: (1) implementations in which a first subset of the processors (e.g., in a first computing device) generates X and an entirely distinct, second subset of the processors (e.g., in a different, second computing device) independently generates Y; (2) implementations in which one or more or all of the processor(s) (e.g., one or multiple processors in the same device, or multiple processors distributed among multiple devices) contribute to the generation of X and/or Y; and (3) other variations. This may similarly be applied to any other component or feature similarly recited (e.g., as “a component”, “a feature”, “one or more components”, “one or more features”, “a plurality of components”, “a plurality of features”). Moreover, the performance of certain of the operations may be distributed among the one or more components, not only residing within a single machine, but deployed across a number of machines. The set of components may be located in a single geographic location (e.g., within a home environment, an office environment, a cloud environment). In other example embodiments, the set of components may be distributed across two or more geographic locations. Further, “a machine-learned model”, equivalent terms (e.g., “machine learning model,” “machine-learning model,” “machine-learned component”, “artificial intelligence”, “artificial intelligence component”), or species thereof (e.g., “a large language model”, “a neural network”) may include a single machine-learned model or multiple machine-learned models, such as a pipeline comprising two or more machine-learned models arranged in series and/or parallel, an agentic framework of machine-learned models, or the like.

An “artificial intelligence” or “artificial intelligence component” may comprise a machine-learned model. A machine-learned model may comprise a hardware and/or software architecture having structural hyperparameters defining the model's architecture and/or one or more parameters (e.g., coefficient(s), weight(s), biase(s), activation function(s) and/or action function type(s) in examples where the activation function and/or function type is determined as part of training, clustering centroid(s)/medoid(s), partition(s), number of trees, tree depth, split parameters) determined as a result of training the machine-learned model based at least in part on training hyperparameters (e.g., for supervised, semi-supervised, and reinforcement learning models) and/or by iteratively operating the machine-learned model according to the training hyperparameters(e.g., for unsupervised machine-learned models).

In some examples, structural hyperparameter(s) may define component(s) of the model's architecture and/or their configuration/order, such as, for example, the configuration/order specifying which input(s) are provided to one component and which output(s) of that component are provided as input to other component(s) of the machine-learned model; a number, type, and/or configuration of component(s) per layer; a number of layers of the model; a number and/or type of input nodes in an input layer of the model; a number and/or type of nodes in a layer; a number and/or type of output nodes of an output layer of the model; component dimension (e.g., input size versus output size); a number of trees; a maximum tree depth; node split parameters; minimum number of samples in a leaf node of a tree; and/or the like. The component(s) of the model may comprise one or more activation functions and/or activation function type(s) (e.g., gated linear unit (GLU), such as a rectified linear unit (ReLU), leaky RELU, Gaussian error linear unit (GELU), Swish, hyperbolic tangent), one or more attention mechanism and/or attention mechanism types (e.g., self-attention, cross-attention), nodes and split indications and/or probabilities in a decision tree, and/or various other component(s) (e.g., adding and/or normalization layer, pooling layer, filter). Various combinations of any these components (as defined by the structural hyperparameter(s)) may result in different types of model architectures, such as a transformer-based machine-learned model (e.g., encoder-only model(s), encoder-decoder model(s), decoder-only models, generative pre-trained transformer(s) (GPT(s))), neural network(s), multi-layer perceptron(s), Kolmogorov-Arnold network(s), clustering algorithm(s), support vector machine(s), gradient boosting machine(s), and/or the like. The structural parameters and components a machine-learned model comprises may vary depending on the type of machine-learned model.

Training hyperparameter(s) may be used as part of training or otherwise determining the machine-learned model. In some examples, the training hyperparameter(s), in addition to the training data and/or input data, may affect determining the parameter(s) of the target machine-learned model. Using a different set of training hyperparameters to train two machine-learned models that have the same architecture (i.e., the same structural hyperparameters) and using the same training data may result in the parameters of the first machine-learned model differing from the parameters of the second machine-learned model. Despite having the same architecture and having been trained using the same training data, such machine-learned models may generate different outputs from each other, given the same input data. Accordingly, accuracy, precision, recall, and/or bias may vary between such machine-learned models.

In some examples, training hyperparameter(s) may include a train-test split ratio, activation function and/or activation function type (e.g., in examples like Kolmogorov-Arnold networks (KANs) where the activation function type is determined as part of training from an available set of activation functions and/or limits on the activation function parameters specified by the training hyperparameters), training stage(s) (e.g., using a first set of hyperparameters for a first epoch of training, a second set of hyperparameters for a second epoch of training), a batch size and/or number of batches of data in a training epoch, a number of epochs of training, the loss function used (e.g., L1, L2, Huber, Cauchy, cross entropy), the component(s) of the machine-learned model that are altered using the loss for a particular batch or during a particular epoch of training (e.g., some components may be “frozen,” meaning their parameters are not altered based on the loss), learning rate, learning rate optimization algorithm type (e.g., gradient descent, adaptive, stochastic) used to determine an alteration to one or more parameters of one or more components of the machine-learned model to reduce the loss determined by the loss function, learning rate scheduling, and/or the like.

In some examples, the structural hyperparameters and/or the training hyperparameters may be determined by a hyperparameter optimization algorithm or based on user input, such as a software component written by a user or generated by a machine-learned model. The machine-learned model may include any type of model configured, trained, and/or the like to generate a prediction output for a model input. In some examples, any of the logic, component(s), routines, and/or the like discussed herein may be implemented as a machine-learned model.

The machine-learned model may include one or more of any type of machine-learned model including one or more supervised, unsupervised, semi-supervised, and/or reinforcement learning models. Training a machine-learned model may comprise altering one or more parameters of the machine-learned model (e.g., using a loss optimization algorithm) to reduce a loss. Depending on whether the machine-learned model is supervised, semi-supervised, unsupervised, etc. this loss may be determined based at least in part on a difference between an output generated by the model and ground truth data (e.g., a label, an indication of an outcome that resulted from a system using the output), a cost function, a fit of the parameter(s) to a set of data, a fit of an output to a set of data, and/or the like. In some examples, determining an output by a machine-learned model may comprise executing a set of inference operations executed by the machine-learned model according to the target machine-learned model's parameter(s) and structural hyperparameter(s) and using/operating on a set of input data.

Moreover, any discussion of receiving data associated with an individual that may be protected, confidential, or otherwise sensitive information, is understood to have been preceded by transmitting a notice of use of the data to a computing device, account, or other identifier (collectively, “identifier”) associated with the individual, receiving an indication of authorization to use the data from the identifier, and/or providing a mechanism by which a user may cause use of the data to cease or a copy of the data to be provided to the user.

Upon reading this disclosure, those of skill in the art will appreciate still additional alternative structural and functional designs through the principles disclosed herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S.C. § 112(f) unless traditional means-plus-function language is expressly recited, such as “means for” or “step for” language being explicitly recited in the claim(s).

What is claimed is:

1. A computer-implemented method comprising:
generating, by one or more processors and using a deterministic hashing function, one or more hash values corresponding to raw data associated with a machine-learned model training process, the raw data comprising a first raw data point associated with a first key and the one or more hash values comprising a first hash value determined for the first raw data point;
storing, by the one or more processors, the one or more hash values in a database, wherein storing the one or more hash values in the database comprises storing the first hash value in association with the first key;
executing, by the one or more processors, a first processing stage of a set of one or more processing stages, the first processing stage comprising using the first raw data point to generate a first processed data point;
generating, by the one or more processors and using the deterministic hashing function, a second hash value for the first processed data point;
storing, by the one or more processors, the second hash value corresponding to the first processed data point in the database in association with the first key;
training a machine-learned model using processed data to generate a trained machine-learned model, the processed data comprising an output of the set of one or more processing stages; and
registering the trained machine-learned model in a model registry.

2. The computer-implemented method of claim 1, wherein the model registry is separate from the database.

3. The computer-implemented method of claim 1, further comprising:
initializing, by the one or more processors, a first directory as a software version control repository and as a data version control (DVC) repository;
replicating, in the first directory, a structure of an experiment directory, the experiment directory storing data files from a machine-learned model training iteration;
adding, by the one or more processors, one or more data files containing the raw data from the experiment directory to the first directory to be tracked by a DVC application, wherein the DVC application stores and monitors changes to the one or more hash values and the hash value corresponding to the first processed data point; and
adding, by the one or more processors, one or more code files from the experiment directory to the first directory to be tracked by a software version control application, wherein the one or more code files comprise instructions for training and using the machine-learned model.

4. The computer-implemented method of claim 1, further comprising:
generating, by the one or more processors and using the deterministic hashing function, one or more experiment hash values corresponding to raw operation data associated with a trained machine-learned model training iteration, the raw operation data comprising a first raw operation data point associated with a first experiment key;
storing, by the one or more processors, the one or more experiment hash values in a database in association with the first experiment key;
executing, by the one or more processors, the first processing stage of a set of processing stages to generate a first processed data point;
generating, by the one or more processors and using the deterministic hashing function, a hash value corresponding to the first processed data point;
storing, by the one or more processors, the hash value corresponding to the first processed data point in the database in association with the first experiment key;
determining, by the trained machine-learned model and based on the first processed data point, an output;
determining, by the one or more processors, a loss based on the output;
adjusting one or more model parameters to reduce the loss; and
storing, by the one or more processors, the one or more model parameters.

5. The computer-implemented method of claim 1, further comprising:
modifying, by the one or more processors, one or more parameters of the trained machine-learned model to generate a tuned machine-learned model;
registering, by the one or more processors, the tuned machine-learned model using a model tagging tool; and
storing, by the one or more processors and using a DVC application, the one or more modified parameters in the database.

6. The computer-implemented method of claim 1, further comprising:
executing, by the one or more processors and based at least in part on the first processed data point, a second processing stage resulting in a modified first processed data point;
generating, by the one or more processors and using the deterministic hashing function, a third hash value for the modified first processed data point, wherein the third hash value is different from the second hash value; and
storing, by the one or more processors, the third hash value in the database in association with the first key and an identification of the second processing stage.

7. The computer-implemented method of claim 1 further comprising:
executing, by the one or more processors, the first processing stage of a set of processing stages on a second raw data point to generate a second processed data point, the second raw data point being associated with a second key;
generating, by the one or more processors and using the deterministic hashing function, a third hash value for the second processed data point;
storing, by the one or more processors, the third hash value in association with the second key;
executing, by the one or more processors, a second processing stage of a set of processing stages on the first processed data point and the second processed data point;
determining, by the one or more processors, that the second processed data point is absent or that no output was generated for the second processed data point after the executing of the second processing stage; and
generating, by the one or more processors, a fourth hash value for the first processed data point.

8. A computer system comprising:
one or more processors; and
one or more memories storing processor-executable instructions that, when executed by the one or more processors, cause the one or more processors to perform operations comprising:
generating, by using a deterministic hashing function, one or more hash values corresponding to raw data associated with a machine-learned model training process, the raw data comprising a first raw data point associated with a first key and the one or more hash values comprising a first hash value determined for the first raw data point;
storing the one or more hash values in a database in association with the first key, wherein storing the one or more hash values in the database comprises storing the first hash value;
executing a first processing stage of a set of one or more processing stages, the first processing stage comprising using the first raw data point to generate a first processed data point;
generating, by using the deterministic hashing function, a second hash value for the first processed data point;
storing the second hash value corresponding to the first processed data point in the database in association with the first key;
training a machine-learned model using processed data to generate a trained machine-learned model, the processed data comprising an output of the set of one or more processing stages; and
registering the trained machine-learned model in a model registry.

9. The computer system of claim 8, wherein the model registry is separate from the database.

10. The computer system of claim 8, wherein the instructions, when executed, further cause the one or more processors to perform operations comprising:
initializing a first directory as a software version control repository and as a data version control (DVC) repository;
replicating, in the first directory, a structure of an experiment directory, the experiment directory storing data files from a machine-learned model training iteration;
adding one or more data files containing raw alternate data from the experiment directory to the first directory to be tracked by a data version control (DVC) application wherein the DVC application stores and monitors changes to the one or more hash values and the hash value corresponding to the first processed data point; and
adding one or more code files from the experiment directory to the first directory to be tracked by a software version control application, wherein the one or more code files comprise instructions for training and using the machine-learned model.

11. The computer system of claim 8, wherein the instructions, when executed, further cause the one or more processors to perform operations comprising:
generating, by using the deterministic hashing function, one or more experiment hash values corresponding to raw operation data associated with a trained machine-learned model training iteration, the raw operation data comprising a first raw operation data point associated with a first experiment key;
storing the one or more experiment hash values in a database in association with the first experiment key;
executing a processing stage of a set of processing stages to generate a first processed data point;
generating, by using the deterministic hashing function, a hash value corresponding to the first processed data point;
storing the hash value corresponding to the first processed data point in the database in association with the first experiment key;
determining, by the trained machine-learned and based on the first processed data point, an output;
determining, by the one or more processors, a loss based on the output;
adjusting one or more model parameters to reduce loss; and
storing, by the one or more processors, the one or more model parameters.

12. The computer system of claim 8, wherein the instructions, when executed, further cause the one or more processors to perform operations comprising:
modifying one or more hyperparameters of the trained machine-learned model to generate a tuned machine-learned model;
registering the tuned machine-learned model using a model tagging tool; and
storing by using a DVC application, the modified hyperparameters in the database.

13. The computer system of claim 8, wherein the instructions, when executed, further cause the one or more processors to perform operations comprising:
executing a second processing stage resulting in a change to the first processed data point;
generating, by using the deterministic hashing function, a third hash value for the first processed data point, wherein the third hash value is different from the second hash value; and
storing the third hash value in the database in association with the first key and an identification of the second processing stage resulting in a change to the first processed data point.

14. The computer system of claim 8, wherein the instructions, when executed, further cause the one or more processors to perform operations comprising:
executing the first processing stage of a set of processing stages on a second raw data point to generate a second processed data point;
generating, by using the deterministic hashing function, a third hash value for the second processed data point;
storing the third hash value in association with a second key;
executing a second processing stage of a set of processing stages on the first processed data point and the second processed data point;
determining that the second processed data point is absent or that no output was generated for the second processed data point after the executing of the second processing stage; and
generating a fourth hash value for the first processed data point.

15. One or more non-transitory computer-readable media storing processor-executable instructions that, when executed by one or more processors, cause the one or more processors to perform operations comprising:
generating, by using a deterministic hashing function, one or more hash values corresponding to raw data associated with a machine-learned model training process, the raw data comprising a first raw data point associated with a first key and the one or more hash values comprising a first hash value determined for the first raw data point;
storing the one or more hash values in a database in association with the first key, wherein storing the one or more hash values in the database comprises storing the first hash value;
executing a first processing stage of a set of one or more processing stages to generate a first processed data point;
generating, by using the deterministic hashing function, a second hash value for the first processed data point;
storing the second hash value corresponding to the first processed data point in the database in association with the first key;
training a machine-learned model using processed data to generate a trained machine-learned model, the processed data comprising an output of the set of one or more processing stages; and
registering the trained machine-learned model in a model registry.

16. The one or more non-transitory computer-readable media of claim 15, wherein the instructions, when executed, further cause the one or more processors to perform operations comprising:
initializing a first directory as a software version control repository and as a data version control (DVC) repository;
replicating, in the first directory, a structure of an experiment directory, the experiment directory storing data files from a machine-learned model training iteration;
adding one or more data files containing raw alternate data from the experiment directory to the first directory to be tracked by a data version control (DVC) application wherein the DVC application stores and monitors changes to the one or more hash values and the hash value corresponding to the first processed data point; and
adding one or more code files from the experiment directory to the first directory to be tracked by software version control application, wherein the one or more code files comprise instructions for training and using the machine-learned model.

17. The one or more non-transitory computer-readable media of claim 15, wherein the instructions, when executed, further cause the one or more processors to perform operations comprising:
generating, by using the deterministic hashing function, one or more experiment hash values corresponding to raw operation data associated with a trained machine-learned model training iteration, the raw operation data comprising a first raw operation data point associated with a first experiment key;
storing the one or more experiment hash values in a database in association with the first experiment key;
executing by a first processing stage of a set of processing stages to generate a first processed data point;
generating by using the deterministic hashing function, a hash value corresponding to the first processed data point;
storing the hash value corresponding to the first processed data point in the database in association with the first experiment key;
determining, by the trained machine-learned model and based on the first processed data point, an output;
determining a loss based on the output;
adjusting one or more model parameters to reduce loss; and
storing the one or more model parameters.

18. The one or more non-transitory computer-readable media of claim 15, wherein the instructions, when executed, further cause the one or more processors to perform operations comprising:
modifying one or more hyperparameters of the trained machine-learned model to generate a tuned machine-learned model;
registering the tuned machine-learned model using a model tagging tool; and
storing, by using a DVC application, the modified hyperparameters in the database.

19. The one or more non-transitory computer-readable media of claim 15, wherein the instructions, when executed, further cause the one or more processors to perform operations comprising:
executing a second processing stage resulting in a change to the first processed data point;
generating, by using the deterministic hashing function, a third hash value for the first processed data point, wherein the third hash value is different from the second hash value; and
storing the second hash value in the database in association with the first key and an identification of the second processing stage resulting in a change to the first processed data point.

20. The one or more non-transitory computer-readable media of claim 15, wherein the instructions, when executed, further cause the one or more processors to perform operations comprising:
executing the first processing stage of a set of processing stages on a second raw data point to generate a second processed data point;
generating, by using the deterministic hashing function, a third hash value for the second processed data point;
storing the third hash value in association with a second key;
executing a second processing stage of a set of processing stages on the first processed data point and the second processed data point;
determining that the second processed data point is absent or that no output was generated for the second processed data point after the executing of the second processing stage; and
generating a fourth hash value for the first processed data.
